(19) United States
(12) Patent Application Publication
(10) Pub. No.: US 2006/0008599 A1
(43) Pub. Date: Jan. 12, 2006

(54) Manufacturing method of ink jet recording paper and ink jet recording paper

(75) Inventor: Kunimasa Hiyama, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc., Tokyo (JP)

(21) Appl. No.: 11/174,792

(22) Filed: Jul. 5, 2005

(30) Foreign Application Priority Data
Jul. 12, 2004 (JP) JP2004-204321

(51) Int. Cl. B41M 5/00

(52) U.S. Cl. 428/32.24

(57) ABSTRACT

A method of manufacturing an ink jet recording paper comprising the steps of: (a) applying a first coating composition containing inorganic microparticles and a binder onto a support to form a porous ink absorbing layer; (b) drying the porous ink absorbing layer; (c) applying a second coating composition onto the porous ink absorbing layer during the drying step (b); and (d) drying the porous ink absorbing layers, wherein the second coating composition exhibits a pH buffering function, and both conditions (1) and (2) are satisfied at the same time: Condition (1) pH^{b}−pH^{c}<1.0<pH^{c}−pH^{a}, Condition (2) pH^{a}<pH^{b}, wherein pH^{a}, pH^{b}, and pH^{c} are respectively a pH value of the first coating composition, a pH value of the second coating composition, and a pH value of a surface of the ink jet recording paper.

This application is based on Japanese Patent Application No. JP2004-204321 filed on Jul. 12, 2004, in Japanese Patent Office, the entire content of which is hereby incorporated by reference.

### TECHNICAL FIELD

This invention relates to a method of manufacturing paper for ink jet recording and the ink jet recording paper manufactured thereby. Specifically, this invention relates to a method of manufacturing ink jet recording paper to achieve photo-like image quality, and ink jet recording paper manufactured thereby.

### BACKGROUND OF THE INVENTION

In recent years, ink jet recording materials have been rapidly improved to approach photo-like image quality. To attain the photo-like image quality of the ink jet recording paper (hereinafter, simply referred to as recording paper) on ink jet recording apparatuses, various improvements have also been made of the ink jet recording paper itself. For example, a void type ink jet recording paper, featuring a porous layer comprising microparticles and a hydrophilic polymer on an extremely smooth support, has become one of the most photo-like image quality kind of paper because the paper is excellent in glossiness, bright coloration, ink absorptivity, and drying capability. Specifically, a non-water-absorbing support can produce an extremely smooth surface without generation of cockling, also called “wrinkling”, after printing and make a more photo-like print and higher in image quality. Thanks to this, this kind of paper has become to gradually prevail gradually in the ink jet recording field.

For example, ink jet recording paper can be divided into two basic types: one type being whose supporting member itself is ink-absorptive and the other type being whose supporting member is provided with an ink absorbing layer. The former type cannot produce high surface ink density since ink is directly absorbed into the support, and the ink solvent absorbed into the support causes wrinkles on printed areas. This cannot produce high quality photo-like prints. Contrarily, although lately there have been many other types having an ink absorbing layer on the support, the paper of this type may still wrinkle when the support absorbs the ink solvent. Further, the ink density of this type of paper tends to diminish because the ink dye ejected onto the ink absorbing layer gradually spreads into the support during storage of the print.

The above problem can be overcome by ink jet recording paper having an ink absorbing layer on a non-water-absorbing support which absorbed absolutely no ink. This can result in high quality photo-like prints.

Paper having an ink absorbing layer on a non-absorbent base material is characterized by high surface smoothness of the base material with less waviness and is preferably employed for prints which require high photo-like quality (being like silver salt image quality) in terms of glossiness, glaze, and visual depth. Gloss type recording paper sheets of higher glossiness and glaze are also possible. These are swelling type recording paper whose non-absorbent base material is coated with a water-soluble binder, as an ink absorbing layer, such as polyvinyl pyrrolidone and polyvinyl alcohol, and void type recording paper whose base material is coated with a microvoid ink absorbing layer made of a pigment or a mixture of pigment and binder.

The porous ink absorbing layer of the void type recording paper is comprised mainly of a hydrophilic binder and microparticles. As such microparticles, inorganic or organic microparticles are well known. Generally, inorganic microparticles have been employed since they are smaller and produce higher gloss. A little hydrophilic binder is added to the microparticles to form voids among them, which results in a porous ink absorbing layer.

In general, the above porous ink absorbing layers have been designed to exhibit various desirable characteristics. For that reason or to improve the characteristics of the layer, use of the various following kinds of additives has been proposed.

1: Stable microparticles to make the layer porous (being approximately 0.1 μm or less) and to give high coloring capability and glossiness to the layer.

2: Low-swelling type hydrophilic binder which has a high microparticle retention force and will not reduce the ink absorption rate.

3: A hydrophilic binder crosslinking agent to increase the ink absorbing rate and the water resistance of the layer.

4: A surface active agent and a hydrophilic polymer which are dispersed on the layer surface to obtain optimum deposited ink dot diameter.

5: A cationic fixing agent and a polyvalent metal compound, to improve permeation and water resistance of the coloring materials.

6: An anti-fading agent to enhance fading resistance of dye images due to light and oxidizing gases.

7: A fluorescent brightening agent and a color tone controlling agent being a reddening agent or bluing agent, to enhance the whiteness of the background.

8: A matting agent and a surface smoothing agent to improve surface slippage.

9: Oil components, latex particles, or water-soluble plasticizers, to produce a flexible porous ink absorbing layer.

10: Various kinds of inorganic salts (being multivalent metal salts) to improve bleeding resistance, water resistance, and weathering resistance of dyes.

11: Acids and alkalis to control the pH of the porous ink absorbing layer.

However, when the above additives are mixed to the coating composition to form the porous ink absorbing layer, various restrictions may arise in terms of stability of manufacturing process.

Particularly, among the above additives, those which control the pH of the layer or coating composition greatly affect the characteristics of the ink jet recording paper, and exhibit various inherent problems which must be solved.

Generally, the coating composition to form the porous ink absorbing layer of the void type ink jet recording paper can be stably prepared at a 3-5 pH acid condition. In an alkali condition, the coating composition tends to cause gelation and coagulation of inorganic microparticles in the coating composition, and therefore becomes difficult to apply. Meanwhile, the pH of the emulsion surface of the ink jet recording paper is dependent upon the pH of the coating composition which forms the porous ink absorbing layer. However, the ink absorbing rate and the coloring capability of the layer tend to be reduced when the pH of the emulsion surface of the paper is in the acid range. So, the pH of the emulsion surface should preferably be neutral or a weak alkali.

To overcome the above shortcomings, various methods have been proposed to control the pH of the layer surface of the ink jet recording paper within the neutral to acidic range by applying an alkaline coating composition of a pH of 8 or more, after a porous ink absorbing layer coating composition is applied in the acidic regions (please refer to, for example, Patent Documents 1-8). However, to have the final layer pH of the ink jet recording paper exhibit the targeted pH, it is necessary to apply an excessive amount of coating composition, at a high pH, to the porous ink absorbing layer. This may cause yellowing of the ink jet recording paper, increase staining in white background areas, and other color irregularities (being stains) when the paper is stored for a long duration.

Patent Document 1: Unexamined Japanese Patent Application Publication No. (hereinafter, referred to as JP-A) 2002-316472.

Patent Document 2: JP-A 2003-191607.

Patent Document 3: JP-A 2003-191626.

Patent Document 4: JP-A 2003-191627.

Patent Document 5: JP-A 2003-335053.

Patent Document 6: JP-A 2004-1288.

Patent Document 7: JP-A 2004-1289.

Patent Document 8: JP-A 2004-25518.

### SUMMARY OF THE INVENTION

This invention has been achieved to overcome the above shortcomings. An object of this invention is to provide a method of manufacturing ink jet recording paper of high coloring capability, fewer ink absorption irregularities, absence of white-ground contamination, and no staining over long term image storage, and an ink jet recording paper manufactured thereby.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is an explanatory schematic drawing of the slotted nozzle-spray coating method of this invention.

FIG. 2 is a simplified sectional view of one example of the slotted nozzle-spray type coating device containing the slotted nozzle spray member.

### DESCRIPTION OF THE PREFERRED EMBODIMENTS

The above object of this invention can be accomplished by the following:

(Item 1.)

A method of manufacturing an ink jet recording paper comprising the steps of:

(a) applying a first coating composition containing inorganic microparticles and a binder onto a support to form a porous ink absorbing layer;

(b) drying the porous ink absorbing layer;

(c) applying a second coating composition on the porous ink absorbing layer during the drying step (b), and

(d) drying the porous ink absorbing layer,

wherein the second coating composition exhibits a pH buffering function, and both conditions (1) and (2) are satisfied at the same time:
pH^{b}−pH^{c}<1.0<pH^{c}−pH^{a} Condition (1)
pH^{a}<pH^{b} Condition (2)
wherein pH^{a}, pH^{b}, and pH^{c} are respectively a pH value of the first coating composition, a pH value of the second coating composition, and a pH value of a surface of the ink jet recording paper.

(Item 2)

The method of manufacturing the ink jet recording paper of Claim 1, wherein the second coating composition exhibits a buffering function in the range of pH 6 to 8.

(Item 3)

An ink jet recording paper wherein the paper is produced by the method of manufacturing the ink jet recording paper of Item 1.

(Item 4)

The ink jet recording paper of Item 3, wherein the pH of the surface layer of the ink jet recording paper is at least 5.5 and at most 8.0.

This invention provides a method of manufacturing ink jet recording paper of high coloring capability, fewer ink absorption irregularities, absence of white-ground contamination, and negligible staining over long term image storage, and an ink jet recording paper manufactured thereby.

### DETAILED DESCRIPTION OF THE PREFERRED EMBODIMENTS

Explained below will be the preferred embodiments to implement this invention.

After careful research and studies of the above problems, it was found that the object of this invention can be attained by a method of manufacturing paper for ink jet recording comprising the steps of: (a) applying a first coating composition containing inorganic microparticles and a binder onto a support to form a porous ink absorbing layer; (b) drying the porous ink absorbing layer; (c) applying a second coating composition on the porous ink absorbing layer during the drying step (b), and (d) drying the porous ink absorbing layer, wherein the second coating composition exhibits a pH buffering function, and both foregoing conditions (1) and (2) are satisfied at the same time; where pH^{a}, pH^{b}, and pH^{c} are respectively a pH value of the first coating composition, a pH value of the second coating composition, and a pH value of a surface of the ink jet recording paper; and have resulted in the realization of this invention.

In other words, the method of manufacturing an ink jet recording paper of this invention (hereinafter, referred to as the manufacturing method of this invention) comprises a step of applying a coating composition to form a porous ink absorbing layer at a comparatively low pH (or preferably even in the acidic region) onto the support of paper, which enables stable coating of the layer without coagulation in the coating composition, and during the drying process of the porous ink absorbing layer, a second coating composition serving a pH buffering function is applied onto the porous ink absorbing layer, which enables stable control of the desired pH in the pH buffering condition, and at the same time conditions (1) and (2) below are satisfied, where pH^{a}, pH^{b}, and pH^{c} are respectively the pH of the coating composition to form the porous ink absorbing layer, pH of the second coating composition, and pH of the emulsion surface of the ink jet recording paper, in that order, which enables optimum control of pH on the emulsion surface of the paper without employing a coating composition of an extremely high pH (e.g. pH of 8 or more).

As a result, the ink jet recording paper can suppress any irregularity in ink absorbing rate, reduction in coloring capability, absence of white-ground contamination, and negligible staining over long term image storage.

Below will be described this invention in detail.

One of the features of the manufacturing method of this invention is that after at least one porous ink absorbing layer, which incorporates inorganic microparticles and a binder on a support of the paper, a second coating composition serving a pH buffering function is applied onto the porous ink absorbing layer during the drying process of the porous ink absorbing layer.

The second coating composition of this invention has a pH buffering function. “pH buffering function” in this invention is a means to minimize pH changes of a coating composition when an acid or a base is added to the composition. A composition is assumed to have a pH buffering function when pH changes of the composition to which acid or base is added, are smaller than pH changes in pure water to which an acid or a base is added.

Any commonly known composition of buffering solutions can be employed to serve as a pH buffering function to the second coating composition of this invention. For example, such buffering solutions can be the Clark-Lubs buffering solution, the Sφorensen buffering solution, the Kolthoff buffering solution, and the Michaelis buffering solution. There may be combinations of the other buffering solutions.

In the manufacturing method of this invention, it is preferable that the second coating composition has a pH buffering function in the range of pH 6-8. This means that the composition exhibits a buffering function at any pH point in the range of pH 6-8, and the composition needs not always have a buffering function over the entire range. A buffering solution composition to accomplish the purpose of this invention can be a combination of potassium dihydrogenphosphate (0.2 mol/l) and sodium hydroxide (0.2 mol/l), a combination of potassium dihydrogenphosphate (0.067 mol/l) and sodium dihydrogenphosphate (0.067 mol/l), or a combination of potassium dihydrogenphosphate (0.1 mol/l) and sodium tetraborate (0.05 mol/l).

One of the features of the ink jet recording paper of this invention is to simultaneously satisfy both conditions (1) and (2) below.
pH^{b}−pH^{c}<1.0<pH^{c}−pH^{a} Condition (1)
pH^{a}<pH^{b} Condition (2)

In other words, it is preferable that the pH of the second coating composition (being pH^{b}) is higher than the pH of the first coating composition to form a porous ink absorbing layer (being pH^{a}) The difference between pH^{b} and pH^{a} is preferably 0.5-5.0 but particularly preferably 0.5-2.5.

Further, the difference between pH^{b} (being the pH of the second coating composition) and pH^{c} (being the pH of the emulsion surface of the ink jet recording paper) is preferably 1.0 or less, and more preferably 0.1-1.0. Further, the difference between pH^{c} (being the pH of the emulsion-surface of the ink jet recording paper) and pH^{a} (being the pH of the coating composition to form a porous ink absorbing layer) is preferably 1.0 or more, but more preferably 1.1-3.0. When the above pHs (being pH^{a}, pH^{b}, and pH^{c}) satisfy the conditions (1) and (2) , the ink jet recording paper exhibits optimal characteristics of uniformity in ink absorbing rate, enhanced coloring capability, pure white base, and high staining resistance during long term image storage.

Any commercial pH meter, for example, HM-30S digital pH meter (manufactured by DKK-TOA Corp.) may be used to measure pH of the coating composition, which forms the porous ink absorbing layer or the second coating composition.

pH of the layer surface of the ink jet recording paper (being pH^{c}) may be measured by the method defined by J. TAPPI Paper Pulp Test Method No. 49. Specifically, it can be measured by dripping, employing a micro-syringe, 10 microliters of ion-exchanged water onto a recording medium, and applying, to the wet area of the recording medium, pH probes (e.g. GST-5213F manufactured by DKK-TOA Corp.) which are connected to a pH meter (e.g. HM-20E manufactured by DKK-TOA Corp). The layer surface pH of the ink jet recording paper of this invention is preferably at least 5.5 and at most 8.0.

In the manufacturing method of this invention, the second coating composition of this invention is applied while the porous ink absorbing layer is drying, preferably after the falling-rate drying of the ink absorbing layer, but more preferably after the end point of drying.

The process of drying the wet porous ink absorbing layer is loosely divided into the following steps: constant-rate drying period, falling-rate drying period, and the end point of drying. During the constant-rate drying period (or the initial drying period), water and a solvent evaporate from the wet porous ink absorbing layer and draw heat from the layer (being latent heat of evaporation). Therefore the surface temperature of the layer remains approximately constant. After the constant-rate drying period, water and the solvent evaporate via interaction with the solute in the coating composition. The surface temperature of the layer rises due to the latent heat and energy to break the interaction. Falling-rate drying takes place when the rate of evaporation of the solvent from the layer surface is greater than the rate of transfer of water in the layer. At the end of the falling-rate drying period, the surface temperature of the layer becomes equal to the temperature of the drying air. This point is known as the end point of drying.

These constant-rate drying period, falling-rate drying period, and end of drying can be identified by the behavior of the surface temperature of the layer. In other words, the period during which the surface temperature is constant is identified as the constant rate drying period. The period during which the surface temperature rises is identified as the falling-rate drying period. The time at which the surface temperature equals to the temperature of the drying air is identified as the end point of drying.

The second coating composition of this invention may contain any other function performing compounds, besides these above that control the pH buffering functions, without departing from the spirit and scope of this invention.

Function performing compounds employable in this invention are water-soluble polyvalent metal salts, various surface active agents such as anionic, cationic, amphoteric, or nonionic surface active agents, anti-fading agents, cationic fixing agents, and crosslinking agents of a hydrophilic binder.

The surface active agent as a function performing compound can control print dot sizes of ink jet recording. Such surface active agents may be anionic, cationic, amphoteric or nonionic surface active agents. It is also possible to employ two or more of such surface active agents in combination. The surface active agent can be added at a rate of approximately 0.01-50 mg per m² of the recording paper. When the amount of the surface active agent exceeds 50 mg per m² of the recording paper, irregularities in the ink jet recording may result.

A function performing compound may be a crosslinking agent of a hydrophilic binder.

Crosslinking agents well known in the art may be employed, of which preferably employed are borates, zirconium salts, aluminum salts, or epoxy crosslinking agents.

The function performing compound may be an image stabilizing agent (hereinafter, referred to as an anti-fading agent), which prevents color fading due to exposure to light and various kinds of oxidizing gases, such as ozone, active oxygen, NOₓ, and SOₓ.

The function performing compound may be a cationic polymer.

Generally, a cationic polymer functions as a dye fixing agent. To improve water resistance and reduce bleeding, it is preferable to add the cationic polymer in advance to the coating composition to form the porous ink absorbing layer. In cases when the coating composition containing the cationic polymer exhibits problems in coating, the overcoating method may be used. For example, if the coating composition which contains the cationic polymer becomes more viscous over time, or when the cationic polymer is distributed as a gradient in the porous layer to improve the coloring capability of the layer, the cationic polymer is preferably supplied with the overcoating method. In this case, the cationic polymer is applied in an amount of about 0.1-5 g per m² of the recording paper.

The function performing compound may be a water-soluble polyvalent metal compound.

Generally, water-soluble polyvalent metal compounds readily tend to coagulate, especially when it is incorporated in a coating composition incorporating inorganic microparticles. This tends to generate coating defects and specifically deteriorates glossiness of the layer. Therefore, the overcoating method is preferable to supply the water-soluble polyvalent metal compound.

Examples of polyvalent metal compounds include, for example, sulfates, chlorides, nitrates, and acetates of metallic ions such as Mg₂⁺, Ca₂⁺, Zn₂⁺, Zr₂⁺, Ni₂⁺, and Al₃⁺.

The above function performing compounds may be employed alone or in combinations. Specifically, it is possible to employ an aqueous solution which contains two or more kinds of anti-fading agents, a solution which contains an anti-fading agent and a crosslinking agent, and a solution which contains an anti-fading agent together with a surface active agent, and further, a crosslinking agent, a polyvalent metal compound, and an anti-fading agent may be employed in combinations.

The solvent of the above function performing compounds may be water, or a mixture of water and a water miscible organic solvent, however it is specifically preferable to employ only water. It is also preferable to employ a mixture of water and a water-miscible low-boiling-point organic solvent (e.g. methanol, ethanol, i-propanol, n-propanol, acetone, and methyl ethyl ketone). The water content in the mixture of water and a water-miscible organic solvent is preferably 50 weight % or more.

The water miscible low-boiling-point organic solvent is an organic solvent which has a solubility of 10 weight % or more in water at room temperature and a boiling point of about at most 120° C.

Any well known coating method may be selected and employed as a method for applying the second coating composition of this invention. For example, well known coating methods include a gravure coating method, a roll coating method, a rod-bar coating method, an air-knife coating method, an extrusion coating method, a curtain coating method or an extrusion coating method using a hopper as described in U.S. Pat. No. 2,681,294. However, it is specifically preferable to employ a slotted nozzle spray device which can apply a very low amount of coating composition, and also from the viewpoint of a reduced drying load of the second coating layer which is applied even when the ink absorbing layer is not completely dried, as well as negligible adverse influence on the ink absorbing layer.

The slotted nozzle spray device is equipped with an array of liquid nozzle holes to eject the coating composition across the coating width. These nozzle holes for the coating composition may be alignal or staggered. A gas nozzle hole is provided near the liquid composition nozzle holes to form droplets by blowing gas towards the liquid exiting the nozzle slit.

Next will be explained a specific example of the slotted-nozzle-spray type coating device applicable as the coating device of this invention.

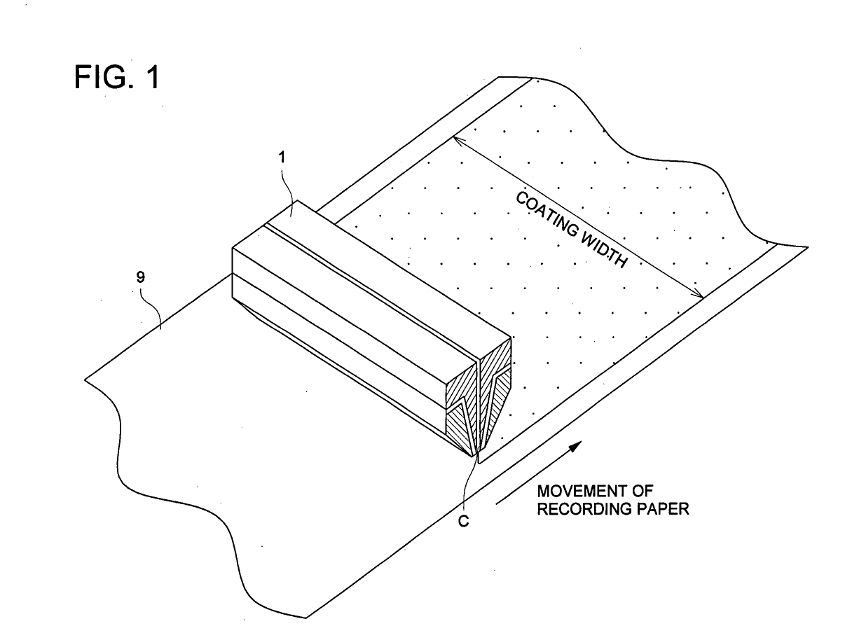

FIG. 1 is an explanatory schematic drawing of a coating method of this invention. In the drawing, reference numeral 1 is a slotted nozzle spray member of the slotted-nozzle-spray type coating device (not shown the entire device in the drawing). Reference number 9 is a longitudinal looped support medium to be coated.

Support (to be coated) 9 is moved longitudinally (in the single barbed arrow) at a constant rate via a conveying means (not shown in the drawing). Slotted nozzle spray means 1 features coating composition nozzle C which extends across the width of support 9 (or across the lesser dimension of the support) with its orifices facing to the surface of the support to be coated. The droplets are sprayed from coating composition nozzle C to cover the surface of conveying support 9. In this case, the wetted area with the coating composition on the support is the coating width (pointed out by the double barbed arrow in FIG. 1). Although the coating width is typically shorter than the lateral dimension of support 9, obviously it may also be equal to the lateral dimension.

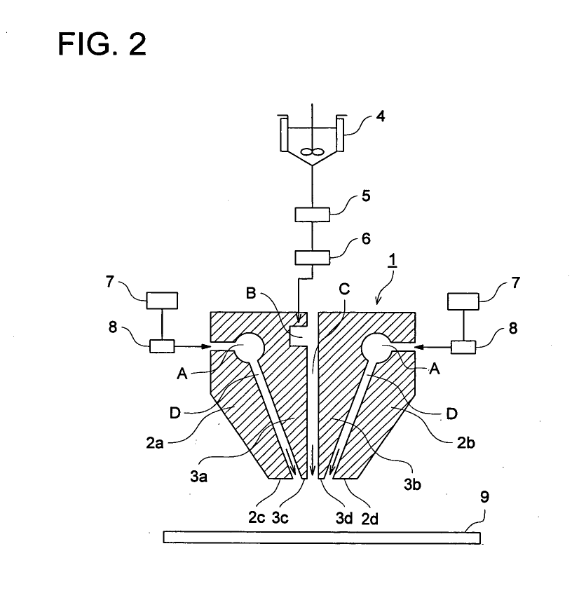

FIG. 2 shows a simplified sectional view of an example of the slotted nozzle-spray type coating device equipped with slotted nozzle spray member 1 of FIG. 1.

Slotted nozzle spray member 1 is structured of a pair of inner die blocks (3a and 3b) and a pair of outer die blocks (2a and 2b) which are adjacent to the inner die blocks (3a and 3b). Paired inner die blocks 3a and 3b form coating composition nozzle C. Gas nozzles D are formed by paired die blocks 2a and 3a and also by 2b and 3b.

In FIG. 2, slotted nozzle spray member 1 contains a pair of gas nozzles D, each of which incorporates gas pocket A, while coating composition nozzle C incorporates coating composition pocket B. A quantity of coating composition is fed into preparation tank 4. In this case, the coating composition can be, for example, a solution which contains a function performing compound which is viscous enough (preferably 0.1-250 mPa.s) to form droplets without forming liquid filaments. The coating composition is fed into coating composition pocket B via pump 5 and flow meter 6, and then fed into coating composition nozzle 3. Similarly, compressed air is supplied to gas pocket A from compressed air source 7 and then channeled to gas nozzle 2. During the coating process, the coating composition is supplied to preparation tank 4 so that a preset quantity of the solution is ejected from liquid nozzle C. At the same time, compressed air from the pair of gas nozzles D is ejected into the ejected liquid, whereby droplets of the coating composition are formed and uniformly deposited on support 9. The method of this invention is primarily characterized by spraying the coating composition in the form of microscopic droplets instead of fiber-like filaments of the liquid composition, which method quickly forms an extremely uniform thin layer on support 9 with a negligible drying load.

Next, explained will be other components of the ink jet recording paper.

The ink jet recording paper of this invention features a support on which provided is a porous ink absorbing layer formed by applying a water-soluble coating composition which contains a hydrophilic binder and inorganic microparticles.

The ink absorbing layer of this invention is primarily formed of inorganic microparticles and a hydrophilic binder. Inorganic microparticles incorporated in the ink absorbing layer include, for example, white inorganic pigments such as precipitated light calcium carbonate, heavy calcium carbonate, magnesium carbonate, kaoline, clay, talc, calcium sulfate, barium sulfate, titanium dioxide, zinc oxide, zinc hydroxide, zinc sulfide, zinc carbonate, hydrotalcite, aluminum silicate salts, diatomite, calcium silicate, magnesium silicate, synthetic amorphous silica, colloidal silica, alumina, colloidal alumina, pseudo boehmite, aluminum hydroxide salts, lithopone, zeolite, and magnesium hydroid. These inorganic microparticles may be employed as primary particles or as secondary coagulated particles.

In order to obtain high quality printed images on the ink jet recording paper of this invention, the inorganic microparticles are preferably silica or alumina particles, as well as further preferably alumina, pseudo boehmite, colloidal silica or microscopic silica particles synthesized with a vapor-phase method, but specifically preferable are microscopic silica particles synthesized via a vapor-phase method. The surfaces of microscopic silica particles synthesized via the vapor-phase method may be modified with aluminum salts. In this case, the content of aluminum in the synthesized silica particles is preferably 0.05-5 weight % to silica.

Any appropriate particle size of the above inorganic microparticles may be employed. However, particle sizes of 1,000 nm or less are preferable. In cases when the particle size exceeds 1,000 nm, glossiness and coloring capability of the layer may deteriorate. Therefore, a particle size of 200 nm or less is preferable, while silica particles of 100 nm or less are most preferable, and further there is theoretically no minimum particle size. However, based on experience from production of inorganic microparticles, the particle size is preferably about 3 nm or greater but more preferably 5 nm or greater.

The mean particle size of the inorganic microparticles can be determined by observation of their cross-section or the surface of the ink absorbing layer employing an electron microscope, measuring the diameter of 100 random particles, and by calculating a simple mean value (being an average of the 100 values). In this case, the particle size of each particle is expressed by the diameter of a circle equivalent to the projected area.

The above inorganic microparticles may exist as primary, secondary, or higher coagulated particles in the porous layer. The above mean particle size is the diameter of an independent particle in the ink absorbing layer observed via an electron microscope.

The mean primary particle size of the above inorganic microparticles is necessarily less than the mean particle size of the particles observed in the porous layer. The mean particle size of the primary inorganic microparticles is preferably 100 nm or less, more preferably 30 nm or less, but still more preferable are microparticles of 4-20 nm.

The content of the inorganic microparticles in the water-soluble coating composition is typically 5-40 weight % but preferably 7-30 weight %. The above inorganic microparticles require enough ink absorbing capability and capable of forming an ink absorbing layer without cracking. The coverage of the inorganic microparticles in the ink absorbing layer is preferably 5-50 g/m² but more preferably 10-25.

The ink absorbing layer may contain any commercial hydrophilic binders, for example, gelatine, polyvinyl pyrrolidone, polyethylene oxide, polyacrylamide, and polyvinyl alcohol. Polyvinyl alcohol is particularly preferable as a hydrophilic binder in the ink jet recording paper of this invention.

Polyvinyl alcohol is a polymer which interacts with inorganic microparticles, resulting in very high retentivity to the inorganic particles, and further is a polymer exhibiting relatively small humidity dependency of hygroscopic property, resulting in relatively lower shrinkage stress during coating and drying, and further exhibits superior aptitude to cracking during coating and drying. Polyvinyl alcohols preferably employed in this invention, include, in addition to regular polyvinyl alcohol obtained by hydrolysis of polyvinyl acetate, modified polyvinyl alcohol such as polyvinyl alcohol whose terminals are modified by cations and also anionic modified polyvinyl alcohol incorporating anionic groups.

Preferably employable polyvinyl alcohol obtained by hydrolysis of polyvinyl acetate is one exhibiting an average polymerization degree of 300 or more, but preferably 1,000-5,000. The saponification degree of polyvinyl alcohol is preferably 70-100% but more preferably 80-99.8%.

The cation modified polyvinyl alcohol is such a one described, for example, in JP-A 61-10483 and contains primary, secondary, tertiary, and/or quaternary amino groups in the main or side chains of the above polyvinyl alcohols. These polyvinyl alcohols may be obtained by saponification of copolymers of vinyl acetate and unsaturated ethylenic monomers which contain cationic groups.

The unsaturated ethylenic monomer incorporating cationic groups may, for example, be trimethyl-(2-acrylamide-2,2-dimethylethyl)ammonium chloride, trimethyl-(3-acrylamide-3,3-dimethylpropyl)ammonium chloride, n-vinyl imidazole, n-methylvinyl imidazole, n-(3-dimethylaminopropyl)methacryl amide, hydroxy ethyltrimethyl ammonium chloride, and trimethyl-(3-methacrylamidepropyl)ammonium chloride.

The ratio of monomer, which contains cationic groups in the cationic modified polyvinyl alcohol, to vinyl acetate is typically 0.1-10 mol %, but preferably 0.2-5 mol %.

The anionic modified polyvinyl alcohols may, for example, be polyvinyl alcohol featuring anionic groups described in JP-A 01-206088, copolymer of vinyl alcohol and vinyl compounds incorporating water-soluble groups described in JP-A 61-237681 and 63-307979, and modified polyvinyl alcohol incorporating water-soluble groups described in JP-A 07-285265.

Nonionic modified polyvinyl alcohol may, for example, be polyvinyl alcohol derivatives prepared by addition of polyalkylene oxide groups to a part of vinyl alcohol described in JP-A 07-9758, and a block copolymer of vinyl alcohol and vinyl compound incorporating hydrophobic groups of JP-A 08-25795.

Two or more polyvinyl alcohols of different degrees of polymerization and modified types thereof may be employed in combination. Specifically, in cases when-polyvinyl alcohol of a polymerization degree of 2,000 or higher is employed, it is preferable to first add 0.05-10 mol % or more preferably 0.1-5 mol % of polyvinyl alcohol to inorganic particles, and then to add polyvinyl alcohol of a polymerization degree of 2,000 or more, which tends to suppress drastic increases in viscosity of the solution.

The mass ratio of inorganic microparticles to the hydrophilic binder in the ink absorbing layer is preferably 2-20. When the mass ratio of the inorganic microparticles is 2 or more, the resulting porous layer exhibits a high enough void ratio. In other words, such a ratio provides sufficient void volume and retains the required high ink absorption rate since the voids are not filled by swollen hydrophilic binder during ink jet recording. Further, when the mass ratio is 20 or less, the ink absorbing layer, even when it is coated thickly, tends to be difficult to cause cracking. The mass ratio of inorganic microparticles to a hydrophilic binder is more preferably 2.5-12 and specifically preferably 3-10.

To prevent bleeding of printed images over long term storage, a cationic polymer may be applied to the ink absorbing layer, other than addition to the second coating composition.

Examples of cationic polymers include polyethylene imine, polyallylamine, polyvinyl amine, condensates of dicyanamide polyalkylene polyamine, condensates of polyalkylene polyamine dicyanamide ammonium salt, condensates of dicyanamide formalin, epichlorohydrin-dialkyl amine addition polymer, a polymer of diallyldimethylammonium chloride, a copolymer of diallyldimethylammonium chloride and SO₂, polyvinyl imidazole, a copolymer of vinyl pyrrolidone and vinyl imidazole, polyvinyl pyridine, poly amidine, chitosan, cationic starch, polymer of vinyl benzyl trimethylammonium chloride, polymer of (2-metacryloyloxyethyl)trimethylammonium chloride, and a polymer of dimethylaminoethylmethacrylate, of which, a cationic polymer of quaternary amine is specifically preferable.

Cationic polymers also include, as examples, those described in “Chemicals and Engineering News” (published Aug. 15 and 25, 1998) and polymer dye fixing agents described in “Guide to Polymer Medical Agents” (published by Sanyo Chemical Industries Ltd.).

A preferably employed cationic polymer in this invention is a polyamide polyamine-epihalorohydrin resin. When employed together with the above compounds, this resin prevents swelling of the ink absorbing layer and consequently improves ink absorptivity and prevents undesired effects of fading.

Among polyamide polyamine-epihalorohydrin resins, a polyamide polyamine-epichlorohydrin resin is specifically preferable, the amount of which is dependent on the content of inorganic microparticles and water-soluble resin. When the resin is applied to a recording medium, its content in the ink absorbing layer is typically 0.01-1.0 g/m² but preferably 0.01-0.5 g/m². When its amount is less than 0.01 g/m², functions of ink absorptivity and the fading prevention are not sufficient, while when its amount is greater than 1.0 g/m², the layer may exhibit cracks during coating and drying.

A method of manufacturing the polyamide polyamine-epihalorohydrin resin is described, for example, in JP-A 06-1842.

The above polyamide polyamine-epihalorohydrin resins may be employed singly or in combination. Further, resins of different degrees of polymerization may be employed in combination. The above polyamide polyamine-epichlorohydrin resins may be synthesized in house or purchased on the market.

A hardener for a water-soluble binder in the porous ink absorbing layer of the ink jet recording paper of this invention may be added not only to the second coating composition but also to the ink absorbing layer.

Any hardeners are employable in this invention as long as they react with the water-soluble binder in the ink absorbing layer, of which, boric acid and its salt are specifically preferable. Other than those, commonly known hardeners may also be employed. Generally, hardeners are compounds incorporating groups to react with the water-soluble binder, or compounds promoting a reaction among different groups contained in the water-soluble binder. They are appropriately selected based on the type of water-soluble binder. Examples of the hardeners include, for example, epoxy hardeners (such as diglycidyl ethylether, ethylene glycol diglycidyl ether, 1,4-butane diol diglycidyl ether, 1,6-diglycidyl cyclohexane, n,n-diglycidyl-4-glycidyl oxyaniline, sorbitol polyglycidyl ether, and glycerol polyglycidyl ether), aldehyde hardener (such as formaldehyde, and glyoxal), active halogen hardeners (such as 2,4-dichloro-4-hydroxy-1,3,5-s-triazine), active vinyl compounds (such as 1,3,5-trisacryloyl-hexahydro-s-triazine, and bisvinyl sulfonyl methylether), and aluminum based alum.

“Boric acid and a salt thereof” mean an oxygen acid having a boron atom as the center atom and a salt thereof. Specifically listed are orthoboric acid, diboric acid, metaboric acid, tetraboric acid, pentaboric acid and octaboric acid and salts thereof.

Boric acid and a salt thereof having a boron atom, as a hardener, may be employed singly or in combination of more than two kinds. Specifically preferred is a mixed aqueous solution of boric acid and borax.

Although boric acid and borax are each employed only in dilute aqueous solutions, the mixture of the solutions may be a concentrated aqueous solution. This enables concentration of the coating composition. Further, this also enables comparatively free-pH control of the added aqueous solution. The total amount of the above hardeners is preferably 1-600 mg/g of the above water-soluble binder.

In the ink jet recording paper of this invention, a polyvalent metal compound may be added not only to the foregoing second coating composition, but also to the ink absorbing layer.

Polyvalent metal compounds employable in this invention include, for example, a metal compound incorporating metals such as aluminum, calcium, magnesium, zinc, iron, strontium, barium, nickel, copper, scandium, gallium, indium, titanium, zirconium, tin, or lead. Further, the polyvalent metallic compounds may be polyvalent metal salts. Of these, compounds of magnesium, aluminum, zirconium, calcium, and zinc are preferable since they are colorless. It is more preferable that the polyvalent metal compound is one which contains a zirconium, aluminum, or magnesium atom, and specifically preferable is one containing a zirconium atom.

A compound containing a zirconium, aluminum, or magnesium atom, employable in this invention, may be any of: a simple or double salts of inorganic and organic acids, organic metallic compounds, or metallic complexes, which may be water-soluble or non-water-soluble, but is preferably uniformly added to any desirable location of the ink absorbing layer.

In the ink jet recording paper of this invention, an amino acid may be employed together with the above polyvalent metal compound.

The amino acid in this invention is a compound which contains an amino group and a carboxyl group in the molecule, which may be any type (being α-, β-, and γ-) of amino acids. Some amino acids feature optical isomers, but in this invention, differences of effects provided by the optical isomers are small. These optical isomers may be employed singly or as a racemic form. For detailed information of amino acids, please refer to “Encyclopedic Dictionary of Chemistry 1” (pocket edition), 1960, Kyoritsu Shuppan Co., Ltd. p. 268-270.

Any commercially known support for conventional ink jet recording paper may be employed, which may be a water-absorbing support, but is preferably a non-absorbing type support. Specifically, from the viewpoint of providing water resistance and to prevent cockling of the recording paper, a non-water absorbing support is preferred. In cases when such a non-water absorbing support is employed, it is essential that control of the pH of the surface of the recording paper is performed only in the ink absorbing layer, because water movement between the support and the ink absorbing layer is blocked. That is, in this invention, application of the second coating composition is essential to adjust the surface pH to the desired pH.

Examples of the water-absorbing type support employable in this invention include, for example, a sheet or a plate of common paper, cloth or wood, however paper is most preferable since it is excellent in water-absorptivity and is most cost effective. As paper supports, employable are chemical pulp (such as LBKP, and NBKP, mechanical pulp (such as GP, CGP, RMP, TMP, CTMP, CMP, and PGW) and wood pulp (such as DIP, and recycled paper pulp). Further, fibrous materials such as synthetic pulp, synthetic fibers, and inorganic fibers may also be employed if appropriate.

To the above paper support, added may be various kinds of commercially known additives, such as sizing agents, pigments, paper strengthening additives, fixing agents, fluorescent brightening agents, wet paper strengthening agents, and cationization agents, as appropriate.

The paper support may be fabricated by adding the selected additives to the fibrous materials such as wood pulp, and forming these into paper sheets via a paper making machine, such as a Fourdrinier paper machine, a cylinder paper machine, or a twin-wire paper machine. Further, it is possible to conduct a sizing-pressing treatment, a coating treatment, or a calendaring treatment with starch or polyvinyl alcohol during the paper making process or via a paper making machine, as appropriate.

Specifically, a non-water-absorbing support is preferable as a support for the ink jet recording paper of this invention. Preferably employable non-water-absorbing supports of this invention are transparent supports and opaque supports. Examples of the transparent supports include film materials made of resins selected from: polyester, diacetate, triacetate, acryl, polycarbonate, polyvinyl chloride, polyimide, cellophane, and celluloid. Of these, preferred is a support exhibiting resistance to radiated heat such as when used as an OHP sheet, for which specifically, polyethylene terephthalate is preferable. The thickness of such a transparent support is preferably 50-200 μm.

Further, as an opaque support, preferably employed are, for example, resin coated paper (being RC paper) featuring a polyolefin resin layer incorporating a white pigment on at least one side of the support, and a so-called white PET made by addition of a white pigment (such as barium sulfate) to polyethylene terephthalate.

Further, it is preferable to conduct corona discharging or undercoating on the support prior to coating of the ink absorbing layer, which increases the adhesion strength between the support and the ink absorbing layer. Further, the ink jet recording paper of this invention is not always colorless as white, and may be a recording sheet of any color of the rainbow.

In the ink jet recording paper of this invention, it is specifically preferable to employ a paper support, both sides of which are laminated via polyethylene, since this support enables formation of high quality photo-like images at low costs. Such polyethylene laminated paper supports will be described below.

The base paper for the paper support employs wood pulp as a main ingredient, and further added may be synthetic pulps such as polypropylene and synthetic fibers such as nylon or polyester, as appropriate. Wood pulp may be LBKP, LBSP, NBKP, NBSP, LDP, NDP, LUKP, and NUKP. It is preferable to employ a higher ratio of wood pulp which contains more short fibers (such as LBKP, NBSP, LBSP, NDP, and LDP). In this case, the content of LBSP and/or LDP is preferably 10-70 weight %.

Chemical pulp (such as sulfate or sulfite pulp), which include fewer impurities, is preferably employed as the above pulp. Pulp which is bleached to increase whiteness may also be employed.

In the base paper, optionally added may be various materials such as sizing agents (e.g. higher fatty acid, or alkylketene dimmer), white pigments (e.g. calcium carbonate, talc, or titanium oxide), paper strength agents (e.g. starch, polyacrylamide, or polyvinyl alcohol), fluorescent brightening agents, moisture retainers (e.g. polyethylene glycol), dispersing agents, and softening agents (e.g. quaternary ammonium).

The degree of water freeness based on CSF Specification of pulp employed for paper making is preferably 200-500 ml. Further, the sum of the weight % of 24-mesh residue and the weight % of 42-mesh residue regarding the fiber length after beating, specified in JIS-P-8207, is preferably 30-70%. Further, the weight % of 4-mesh residue is preferably at most 20 weight %.

The basis weight of the base paper is preferably 30-250 g and specifically preferred is 50-200 g. The thickness of the base paper is preferably 40-250 μm.

During the paper making stage, or alternatively after paper making, the base paper may be subjected to a calender treatment to enhance excellent smoothness. The density of the base paper is generally 0.7-1.2 g/cm³ (based on JIS-P-8118). Further, the stiffness of the base paper is preferably 20-200 g under the conditions specified in JIS-P-8143.

Surface sizing agents may be applied to the surface of the base paper. As surface sizing agents, the foregoing sizing agents capable of adding to the base paper may be employed.

The pH of the base paper is preferably 5-9, when determined employing a hot water extraction method specified in JIS-P-8113.

Polyethylene, which covers both surfaces of the base paper, is comprised mainly of low density polyethylene (LDPE) and/or high density polyethylene (HDPE), but it is also possible to employ small amount of other LLDPE and polypropylene.

Specifically, the polyethylene layer on the ink absorbing layer side is preferably one which opacity and whiteness are improved by addition of rutile- or anatase-type titanium oxide into polyethylene, as is widely done in preparation of photographic printing paper. The amount of titanium oxide is 3-20 weight % of polyethylene, and preferably 4-13 weight %.

The polyethylene-coated paper may be employed as glossy paper, or as matte- or silk-finished paper, which are formed by extruding of molten polyethylene onto the surface of the base paper to give a matte- or silk-pattern to the coated polyethylene surface, as seen on regular photographic printing paper.

It is specifically preferable to keep the mixture content of the above polyethylene coated paper at 3-10 weight %.

Various kinds of publically-known additives may be added to the ink jet recording paper of this invention. For example, examples of the additives include polystyren, polyacrylic esters, polymethacrylic esters, polyacrylamides, polyethylene, polypropylene, polyvinyl chloride, polyvinylidene chloride, or these copolymers, microparticles of organic latex (e.g. melamine resin), cation or nonionic surface active agents, UV absorbing agents described in JP-A Nos. 57-74193, 57-87988, and 62-261476, fading preventing agents described in JP-A Nos. 57-74192, 57-87989, 60-72785, 61-146591, 01-95091, and 03-13376, fluorescent brightening agent described in JP-A Nos. 59-42993, 59-52689, 62-280069, 61-242871, and 04-219266, pH controlling agents (e.g. sulfuric acid, phosphoric acid, citric acid, sodium hydroxide, potassium hydroxide, or potassium carbonate), antifoaming agents, antiseptic agents, viscosity increasing agents, antistatic agents, and matting agents.

A method of manufacturing the ink absorbing layer for the ink jet recording paper of this method may be adequately selected from publically-known coating methods. By the selected method, the ink absorbing layer is formed on a support by coating and drying. Employable coating methods are, for example, a roll coating method, a rod-bar coating method, an air-knife coating method, a spray coating method, a curtain coating method, a slide-bead coating method which employs a hopper described in U.S. Pat. Nos. 2,761,419 and 761,791, and an extrusion coating method.

When two or more ink absorbing layers are simultaneously applied onto the base support, the viscosities of the coating compositions is 5-100 mPa.s and preferably 10-50 mPa.s for the slide-bead coating method, and 5-1,200 mPa.s and preferably 25 to 500 mPa.s for the curtain coating method.

The viscosity of the coating composition at 15° C. is 100 mPa.s or more, preferably 100-30,000 mPa.s, more preferably 3,000-30,000 mPa.s, and still more preferably 10,000-30,000 mPa.s.

A preferable coating and drying method comprises the steps of heating the coating compositions to 30° C. or higher, applying the coating compositions to the base support with a simultaneous coating method, temporarily cooling the coated layers down to 1-15° C., and drying the layers at 10° C. or higher. It is preferable to prepare, apply and dry the coating compositions at Tg or lower temperature of the thermoplastic resin so that the thermoplastic resin in the surface layer may not form a film when the coating compositions are prepared, applied, and dryed. It is more preferable to dry the coated layers at a wet-bulb temperature of 5-50° C. and a layer temperature of 10-50° C. Further, it is preferable to place the just-coated layers flat and cool them in order to make the coated layer uniform.

In the method of manufacturing ink jet recording paper of this invention, after the ink absorbing layer is coated and dried with the second coating composition, it is preferable to heat-treat the layers at 35-70° C. (including both) for 24 hours to 60 days.

The heat-treatment conditions are not specifically limited as long as the coated layers are heat-treated at 35-70° C. for 24 hours to 60 days. Preferable heat-treatment is, for example, heat-treating at 36° C. for 3 days to 4 weeks, heat-treating at 40° C. for 2 days to 2 weeks, or heat-treating at 55° C. for 1-7 days. This heat-treatment promotes hardening or crystallization of the water-soluble binder. As the result, the ink absorbing layer can have preferable ink absorptivity.

The recording paper of this invention is preferably employed as recording paper for water-based pigment ink or water-based dye ink, both of which are a coloring agent containing ink.

The water-based dye ink employs a water-soluble dye as a coloring agent and contains water or mixture of water and water-miscible organic solvent, as a solvent of the ink. Typical dyes for the ink are acid dyes, substantive dyes or basic dyes, which water-solubility is improved by applying sulfo groups or carboxy groups to the dyes of the conventionally well-known azo dyes, xanthen dyes, phthalocyanine dyes, quinone dyes, and anthraquinone dyes.

As pigments for the pigment ink, employable are inorganic or organic pigments which are publically known for ink jet printing. Examples of inorganic pigments for ink include a carbon black, a titanium oxide, and an iron oxide. Further, as organic pigments, listed are azo pigments, phthalocyanine pigments, anthraquinone pigments, quinacridone pigments, indigo pigments, or lake pigments obtained by reacting a water-soluble dye and polyvalent metal ions.

These pigment particles are preferably employed together with a dispersing agent or a dispersion stabilizer such as hydrophilic polymers or surface active agents. The pigment particles are preferably dispersed to have the mean particle size of about 70-150 μm employing these dispersing agents and dispersion stabilizers.

The amount of dye or pigment of the above coloring agent in the ink is approx.0.2-10 weight %, although it depends on the type of dye or pigment, the ink usage type whether a dark or light ink is used, and the type of recording paper.

In the ink containing a coloring agent, various kinds of solvents are employed. As ink solvents, water or water-miscible organic solvents are employed singly or in combination. Specifically, listed are alcoholic solvents (e.g. ethanol, 2-propanol, ethylene glycol, propylene glycol, glycerin, 1,2-hexane diol, 1,6-hexane diol, diethylene glycol monomethylether, and tetraethylene glycol monomethylether), amides (e.g. 2-pyrolidinon, n-methylpyrolidone, and n,n-dimethyl acetamide), amines (e.g. triethanol amine, n-ethylmorpholine, and triethylene tetramine), sulfonlane, dimethylsulfoxide, urea, acetonitrile, and acetone. These solvents may be employed singly or in combination.

Further, in the above ink containing a coloring agent, employed may be various kinds of surface active agents to increase the permeability of the ink solvent and for the other purpose. Anionic or nonionic surface active agents are preferably employed as such surface active agents. Of these, acetylene glycol surface active agents are specifically preferred.

### EXAMPLE

This invention will be described in further detail by way of examples, but this invention is not limited to these examples.

Preparation of Ink Jet Recording Paper

Preparation of Specimen 101

Preparation of Support

A support was prepared by adding 1 weight part of polyacrylamide, 4 weight parts of ash (being talc), 2 weight parts of cationic starch, 0.5 weight parts of polyamide epichlorohydrin resin, and any parts of alkylketene dimer (as a sizing agent), to 100 parts of woodpulp (LBKP/NBSP=50/50), making this slurry into a base sheet of a basis weight of 170 g/m² by a Fourdrinier device, calendaring thereof, coating one side of the base sheet with a layer of low-density polyethylene resin (at a density of 0.92) of 28 μm thick which contains 7 weight % of anatase type titanium oxide and a small amount of a color controlling agent, at 320° C. by the fusion-extrusion coating method, immediately cooling thereof employing a mirror-finished cooling roller, and then coating the other side of the base sheet with a layer of polyethylene resin mixture of high-density polyethylene resin of 0.96 density, low-density polyethylene resin of 0.92, in the ratio of 70:30, to become 32 μm thick by the fusion-extrusion coating method.

Then, the titanium oxide containing side of the support was subjected to a corona discharge treatment, and coated with an undercoating layer of gelatin (being 0.05 g/m²).

The other side of the support was coated with styrene/acryl emulsion which contains silica particles (as a matting agent) of the mean particle size of approx. 1.0 μm and a small amount of a cationic polymer (as a conductant agent), to obtain the dried layer thickness of approx. 0.5 μn. This is a support on which an ink absorbing layer is applied.

The characteristics of the back side of the support were: glossiness of approx. 18%, mean roughness (Ra) along central line of approx. 4.5 μm, and Beck's smoothness of 160-200 seconds.

The water content of the prepared base paper for the support was 7.0-7.2%.

Preparation of Ink Absorbing Layer Coating Composition

A coating composition of the following compositions was prepared for the ink absorbing layer in a procedure below.

Preparation of Titanium Oxide Dispersion Solution 1

A uniform titanium oxide dispersion solution was prepared by adding 20 kg of titanium oxide at the mean particle size of approx. 0.25 μm (being W-10, produced by Ishihara Sangyo Co., Ltd.) to 90 liters of aqueous solution containing 150 g of sodium tripolyphosphate at pH of 7.5, 500 g of polyvinyl alcohol (being PVA235, produced by Kuraray Co., Ltd.), 150 g of cationic polymer (P-1), and 10 g. of defoaming agent (SN381, Sun-Nobuko Co., Ltd.), dispersing them in the liquid by a high-pressure homogenizer (by SANWA Industries Co., Ltd.), and adding water to the liquid to bring the total volume to 100 L.

Cationic polymer (P-1)

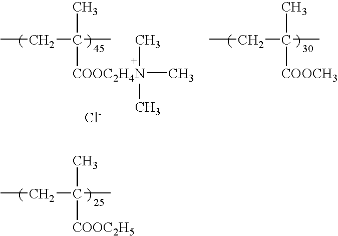

Preparation of Silica Dispersion Solution 1

| | | |
|---|---|---|
| Water | 71 | liters |
| Boric acid | 0.27 | kg |
| Borax | 0.24 | kg |
| Ethanol | 2.2 | liters |
| 25% aqueous solution of | 17 | liters |
| cationic polymer (P-1) | | |
| 10% aqueous solution of fading | 8.5 | liters |
| preventing material (AF1*1) | | |
| Aqueous solution of fluorescent | 0.1 | liter |
| brightening agent (*2) | | |

Pure water was added to bring the total volume to 100 L.

50 kg of vapor-phase fabricated silica (at mean primary particle size of approx. 12 nm) was added as inorganic microparticles to the above solution, and dispersed by the dispersing method described in Example 5 of JP-A 2002-47454, to obtain Silica Dispersion Solution 1.

1: Fading preventing material (AF-1) HO—N(C₂H₄SO₃Na)₂

2: UVITEX NFW liquid (produced-by Chiba Specialties Chemicals Co., Ltd.)

Preparation of Silica Dispersion Solution 2

Silica Dispersion Solution 2 was prepared in the same manner as Silica Dispersion Solution 1, except that cationic polymer (P-2) was employed instead of cationic polymer (P-1).

Cationic polymer (P-2) 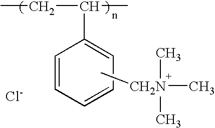
Preparation of Coating Composition for Ink Absorbing Layer

Coating compositions for 1st, 2nd, 3rd, and 4th ink absorbing layers were prepared in the procedure below.

Coating Composition for First Layer

The following additives were sequentially added to 610 ml of Silica Dispersion Solution 1 while the solution was stirred at 40° C.

| | | |
|---|---|---|
| 5% aqueous solution of polyvinyl alcohol | 220 | ml |
| (being PVA235, produced by Kuraray Co., Ltd.) | | |
| 5% aqueous solution of polyvinyl alcohol | 80 | ml |
| (being PVA245, produced by Kuraray Co., Ltd.) | | |
| Dispersion liquid of titanium oxide | 30 | ml |
| Dispersion liquid of polybutadiene (at mean | 15 | ml |
| particle size of approx. 0.5 μm, | | |
| concentration of solid of 40%) | | |
| 5% aqueous solution of surface active agent | 1.5 | ml |
| (SF1) | | |

| | |
|---|---|
| Pure water | to make the |
| | total to 1,000 ml |

The pH of this coating composition for the first layer was 4.6 at 40° C., measured by a digital pH meter, HM-30S, manufactured by DKK-TOA Corp.

Coating Composition for Second Layer

The following additives were sequentially added to 630 ml of Silica Dispersion Solution 1 while the solution was stirred at 40° C.

| | |
|---|---|
| 5% aqueous solution of polyvinyl alcohol | 180 ml |
| (PVA235, produced by Kuraray Co., Ltd.) | |
| 5% aqueous solution of polyvinyl alcohol | 80 ml |
| (PVA245, produced by Kuraray Co., Ltd.) | |
| Dispersion solution of polybutadiene (at mean | 15 ml |
| particle size of approx. 0.5 μm, | |
| concentration of solid of 40%) | |
| Pure water | to make the total |
| | volume to 1,000 ml |

The pH of this coating composition for the second layer was 4.6 at 40° C., measured by a digital pH meter, HM-30S, manufactured by DKK-TOA Corp.

Coating Composition for Third Layer

The following additives are sequentially added to 650 ml of Silica Dispersion Solution 2 while the solution was stirred at 40° C.

| | |
|---|---|
| 5% aqueous solution of polyvinyl alcohol | 180 ml |
| (PVA235, KURARAY CO., LTD) | |
| 5% aqueous solution of polyvinyl alcohol | 80 ml |
| (PVA245, KURARAY CO., LTD) | |
| Pure water | to make a |
| | total of 1,000 ml |

The pH of this coating composition for the third layer was 4.4 at 40° C., measured by a digital pH meter, HM-30S, manufactured by DKK-TOA Corp.

Coating Composition for the Fourth Layer

The following additives are added to 650 ml of Silica Dispersion Solution 2 in sequence while the solution was stirred at 40° C.

| | |
|---|---|
| 5% aqueous solution of polyvinyl alcohol | 180 ml |
| (PVA235, KURARAY CO., LTD) | |
| 5% aqueous solution of polyvinyl alcohol | 80 ml |
| (PVA245, KURARAY CO., LTD) | |
| 50% aqueous solution of saponin | 4 ml |
| 5% aqueous solution of surface active | 6 ml |
| agent (SF1) | |
| Pure water | to make a |
| | total of 1,000 ml |

The pH of this coating composition for the fourth layer was 4.4 at 40° C., measured by a digital pH meter, HM-30S manufactured by DKK-TOA Corp.

Formula 3

Surface active agent (SF1)

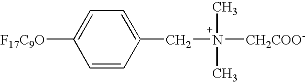

The above prepared coating compositions were filtered by two stage filtration employing filters capable of collecting a size of 20 μm.

Each of the above coating compositions showed a viscosity of 30-80 mPa.s at 40° C. and 30,000-100,000 mPa.s at 15° C.

Coating

The above coating compositions were simultaneously applied onto the foregoing support at 40° C. employing a 4-layer curtain coater on a coating line at a coating width of about 1.5 m, and a coating rate of 100 m/minute.

Wet Layer Thickness

| | |
|---|---|
| First layer: | 35 μm |
| Second layer: | 45 μm |
| Third layer: | 45 μm |
| Fourth layer: | 40 μm |

Immediately after the coating compositions were applied, the coated layers were cooled for 20 seconds in a cooling zone maintained at 8° C. Then the layers were dried for 30 seconds by hot air of 20-30° C. and a relative humidity (RH) of 20° C. or lower for 30 seconds, for 120 seconds by air of 60° C. and an RH of 20% or lower, and for 60 seconds at 55° C. and an RH of 20% or lower. The surface temperature of the layers in the constant-rate drying area was 8-30° C. After it was gradually increased in the falling-rate drying zone, humidity of the coated layers was controlled in the humidity control zone at 23° C. and 40-60% RH, to obtain Sample 101 of an ink jet recording paper.

The pH of this Sample 101 was 4.5, measured by a pH meter, DKK-TOA HM-20E, employing emulsion pH probes DKK-TOA GST-5213, according to the method specified by J.TAPPI Paper Pulp Test Method No. 49.

Preparation of Sample 102

Preparation of Second Coating Composition 1

| | |
|---|---|
| Potassium dihydrogen phosphate | 0.0067 mol |
| Dibasic sodium phosphate | 0.0603 mol |

Each of the above additives was dissolved with pure water, and the total volume was brought to 1,000 ml, to prepared Second Coating Composition 1.

The pH of this Second Coating Composition 1 was 7.7, measured with the above method.

Formation of Second Coating Layer

In the preparation of above Sample 101, after the four ink absorbing layers (being the 1st -4th layers) applied at the start point of the falling-rate drying zone and passed through the cooling zone, above Second Coating Composition 1 was further applied onto the top of the ink absorbing layers at a coating rate of 100 m/minute to make a wet layer thickness of 20.0 μm, employing one slotted nozzle spray device described in FIG. 2, and dryed. The resulting inkjet recording paper was designated as Sample 102.

The pH of Sample 102 was 7.1, measured with the above method.

Preparation of Samples 103-108

Samples 103-108 were prepared in the same procedures as Sample 102 except that their compositions were changed as shown in Table 1.

The detailed compositions of Second Coating Compositions will be listed below.

Preparation of Second Coating Composition 2

| | |
|---|---|
| Potassium dihydrogen phosphate | 0.0034 mol |
| Dibasic sodium phosphate | 0.0637 mol |

The above additives were dissolved in pure water and the total volume was brought to 1,000 ml. by addition of pure water, to obtain Second Coating Composition 2.

Preparation of Second Coating Composition 3

| | |
|---|---|
| Potassium dihydrogen phosphate | 0.062 mol |
| Sodium tetraborate | 0.019 mol |

The above additives were dissolved in pure water and the total volume was brought to 1,000 ml by addition of pure water, to obtain Second Coating Composition 3.

Preparation of Second Coating Composition 4

| | |
|---|---|
| Sodium acetate | 0.010 mol |

The above additive was dissolved in pure water and the total volume was brought to 1,000 ml by addition of pure water, to obtain Second Coating Composition 4.

Preparation of Second Coating Composition 5

| | |
|---|---|
| Sodium hydrogen carbonate | 0.10 mol |

The above additive was dissolved in pure water and the total volume was brought to 1,000 ml by addition of pure water, to obtain Second Coating Composition 5.

Preparation of Second Coating Composition 6

| | |
|---|---|
| Potassium dihydrogen phosphate | 0.30 mol |

The above additive was dissolved in pure water and the total volume was brought to 1,000 ml by addition of pure water, to obtain Second Coating Composition 6.

Preparation of Second Coating Composition 7

| | |
|---|---|
| Sodium hydroxide | 0.010 mol |

The above additive was dissolved in pure water and the total volume was brought to 1,000 ml by addition of pure water, to obtain Second Coating Composition 7.

Preparations of Samples 109-111

Samples 109-111 were prepared in the same procedure as Samples 101, 102, and 108, except that the contents of boric acid and borax in the coating compositions were changed and pH's of the coating compositions were changed (please refer to Table 1).

TABLE 1

| | | | | | Second | | | |
|---|---|---|---|---|---|---|---|---|
| | Coating composition | | | | coating | | | |
| | pH (pH^{a}) | | | | composition | | | |
| Sample | | 2nd | | 4th | Liquid | | Paper emulsion | |
| No. | 1st layer | layer | 3rd layer | layer | No. | pH^{b} | side pH^{c} | Remarks |
| 101 | 4.6 | 4.6 | 4.4 | 4.4 | — | — | 4.5 | Comparative |
| | | | | | | | | example |
| 102 | 4.6 | 4.6 | 4.4 | 4.4 | 1 | 7.7 | 7.1 | Example of |
| | | | | | | | | this |
| | | | | | | | | invention |
| 103 | 4.6 | 4.6 | 4.4 | 4.4 | 2 | 8.0 | 7.5 | Example of |
| | | | | | | | | this |
| | | | | | | | | invention |
| 104 | 4.6 | 4.6 | 4.4 | 4.4 | 3 | 7.0 | 6.6 | Example of |
| | | | | | | | | this |
| | | | | | | | | invention |
| 105 | 4.6 | 4.6 | 4.4 | 4.4 | 4 | 7.4 | 6.5 | Example of |
| | | | | | | | | this |
| | | | | | | | | invention |
| 106 | 4.6 | 4.6 | 4.4 | 4.4 | 5 | 8.5 | 6.0 | Comparative |
| | | | | | | | | example |
| 107 | 4.6 | 4.6 | 4.4 | 4.4 | 6 | 9.0 | 6.7 | Comparative |
| | | | | | | | | example |
| 108 | 4.6 | 4.6 | 4.4 | 4.4 | 7 | 13.0 | 8.5 | Comparative |
| | | | | | | | | example |
| 109 | 3.8 | 3.8 | 3.6 | 3.6 | — | — | 3.7 | Comparative |
| | | | | | | | | example |
| 110 | 3.8 | 3.8 | 3.6 | 3.6 | 1 | 7.7 | 6.9 | Example of |
| | | | | | | | | this |
| | | | | | | | | invention |
| 111 | 3.8 | 3.8 | 3.6 | 3.6 | 7 | 13.0 | 7.6 | Comparative |
| | | | | | | | | example |

Evaluation of Ink Jet Recording Paper

Each of the above prepared samples was evaluated with the methods below.

Evaluation of Image Uniformity (Mottling Resistance)

Green solid images were printed out on the samples employing Canon Ink Jet Printer BJF870 and the genuine inks the image uniformity was evaluated based on the following criteria.

A: Extremely uniform solid images were noted.

B: Almost uniform images were noted when viewed 30 cm away from the print.

C: Almost uniform images were noted when viewed 60 cm away from the print.

D: Mottles were noted even when viewed 60 cm or more away from the print.

Evaluation of Coloring Ability (Maximum Density)

Solid yellow, magenta, and cyan images were printed out on each of the samples employing Canon Ink Jet Printer BJF870 and CANON genuine inks at the-maximum output. The maximum density (Dmax) of each image was measured by the optical densitometer (X-Rite 938 Spectroscopic Densitometer).

Evaluation of White Background and Staining

The blue reflection density (D_{B}⁰) was measured in the blank area (unprinted area) of each ink jet recording paper sheet for evaluation of the white background. Each blank sheet was kept at 55° C. and 20% RH. for 24 hours, and then its blue reflection density was measured (D_{B}¹). The difference of the reflection densities of ΔDB=D_{B}¹−D_{B}⁰ was calculated, to determine “staining” after forced deterioration.

The results of evaluation are listed in Table 2.

TABLE 2

| | Image | | | | | | |
|---|---|---|---|---|---|---|---|
| | uniformity | Coloring | | | White | | |
| Sample | (Mottling | ability | | | groud | Staining | |
| No. | resistance) | Dmax_{B} | Dmax_{G} | Dmax_{R} | characteristic | resistance | Remarks |
| 101 | C | 1.83 | 1.94 | 2.12 | 0.03 | 0.02 | Comparative |
| | | | | | | | example |
| 102 | A | 1.87 | 1.98 | 2.19 | 0.03 | 0.03 | Example of |
| | | | | | | | this |
| | | | | | | | invention |
| 103 | A | 1.88 | 1.98 | 2.18 | 0.03 | 0.03 | Example of |
| | | | | | | | this |
| | | | | | | | invention |
| 104 | B | 1.86 | 1.97 | 2.18 | 0.03 | 0.02 | Example of |
| | | | | | | | this |
| | | | | | | | invention |
| 105 | B | 1.85 | 1.97 | 2.17 | 0.03 | 0.02 | Example of |
| | | | | | | | this |
| | | | | | | | invention |
| 106 | B | 1.87 | 1.97 | 2.16 | 0.04 | 0.06 | Comparative |
| | | | | | | | example |
| 107 | B | 1.84 | 1.95 | 2.16 | 0.04 | 0.05 | Comparative |
| | | | | | | | example |
| 108 | A | 1.85 | 1.96 | 2.22 | 1.10 | 0.08 | Comparative |
| | | | | | | | example |
| 109 | D | 1.80 | 1.92 | 2.04 | 0.03 | 0.01 | Comparative |
| | | | | | | | example |
| 110 | B | 1.84 | 1.96 | 2.16 | 0.03 | 0.02 | Example of |
| | | | | | | | this |
| | | | | | | | invention |
| 111 | A | 1.86 | 1.95 | 2.18 | 0.08 | 0.08 | Comparative |
| | | | | | | | example |

As seen from Table 2, it is apparent that the image uniformity and the coloring ability of ink jet recording paper become better as the emulsion surface pH of the paper is set higher. Further, it is apparent that the second coating composition of this invention improves the whiteness of the ground and staining resistance after the forced deterioration.

### EXPLANATION OF SYMBOLS IN THE DRAWINGS

1: Slotted nozzle spray member
1d: Shim
2a, 2b: Outer die block
2c, 2d: Bottom of the outer die block
3a, 3b: Inner die block
3c, 3d: Bottom of the inner die block
4: Control tank
5: Pump
6: Flow meter
7: Compressed air source
8: Valve
9: Support (to be coated)
A: Gas pocket
B: Coating composition pocket
C: Coating composition nozzle
D: Gas nozzle

What is claimed is:

1. A method of manufacturing an ink jet recording paper comprising the steps of:
(a) applying a first coating composition containing inorganic microparticles and a binder onto a support to form a porous ink absorbing layer;
(b) drying the porous ink absorbing layer;
(c) applying a second coating composition onto the porous ink absorbing layer during the drying step (b); and
(d) drying the porous ink absorbing layers,
wherein the second coating composition exhibits a pH buffering function, and both conditions (1) and (2) are satisfied at the same time:
pH^{b}−pH^{c}<1.0<pH^{c}−pH^{a} Condition (1)
pH^{a}<pH^{b} Condition (2)
wherein pH^{a}, pH^{b}, and pH^{c} are respectively a ph value of the first coating composition, a ph-value of the second coating composition, and a ph value of a surface of the ink jet recording paper:

2. The method of manufacturing the ink jet recording paper of claim 1, wherein the second coating composition exhibits a buffering function in the range of pH 6 to 8.

3. An ink jet recording paper wherein the paper is produced by the method of manufacturing the ink jet recording paper of claim 1.

4. The ink jet recording paper of claim 3, wherein the pH of the surface layer of the ink jet recording paper is at least 5.5 and at most 8.0.
